(19) United States
(12) Patent Application Publication
(10) Pub. No.: US 2016/0048213 A1
(43) Pub. Date: Feb. 18, 2016

(54) GESTURE DETECTION IN THREE DIMENSIONS

(71) Applicant: Google Technology Holdings LLC, Mountain View, CA (US)

(72) Inventor: John Zafiris, Hawthorn Woods, IL (US)

(21) Appl. No.: 14/458,454

(22) Filed: Aug. 13, 2014

(51) Int. Cl. G06F 3/01; G06F 3/0488; G06F 3/044; G06F 3/041

(52) U.S. Cl. CPC G06F 3/017; G06F 3/0416; G06F 3/04883; G06F 3/044; G06F 2203/04104; G06F 2203/04108; G06F 2203/04808

(57) ABSTRACT

Three dimension gesture techniques and touch sensor modes are described. In one or more implementations, touch sensors of a display device may be configured to operate in a mutual capacitance mode and a self-capacitance mode. This may be leveraged to support a variety of functionality, such as to recognize gestures in the self-capacitance mode, wake components of a computing device, and so on.

### BACKGROUND

Computing devices may be configured to support a variety of different interactions. Some conventional techniques used to support interaction with the computing device, however, may consume a significant amount of power and require additional hardware. Thus, these conventional techniques may have an adverse effect on resource consumption and other functionality of the computing device as well as with other devices disposed in the vicinity of the computing device.

One example of such a conventional technique to interact with the computing device uses infrared (IR) sensors, which may be used to sense presence of an object to detect a gesture that does not involve contact and thus may be used to support “off screen” gesture detection as part of touchscreen functionality of a display device. For example, a user may position a finger over a display of an item displayed by a display device but not touch the display device for detection as a hover gesture, may wave a hand to make a swipe gesture to turn a page, and so on. However, inclusion of conventional infrared sensors adds to the cost of the computing device, typically exhibits poor operation in bright light, may have “dead spots” that are not detectable using the sensors, may interfere with other devices such as IR remotes for televisions, and may consume significant amounts of power.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ gesture detection in three dimension techniques described herein.

FIG. 2 depicts an example implementation showing an example of touch sensors of FIG. 1 in greater detail.

FIGS. 3 and 4 depict examples of scanning in a self-capacitance mode using touch sensors of a computing device of FIG. 2.

FIG. 5 depicts an example implementation in which detection of a gesture in a self-capacitance mode is utilized to interact with a notification output by a display device of the computing device of FIG. 2.

FIG. 6 depicts an example implementation in which detection of an object in a self-capacitance mode is used to switch to a mutual-capacitance mode.

FIG. 7 is a flow diagram depicting a procedure in an example implementation in which a plurality of touch sensors modes are employed to configure touch sensors to detect proximity of an object.

FIG. 8 is a flow diagram depicting a procedure in an example implementation in which a gesture is recognized that is detected using a self-capacitance mode of touch sensors of a display device, the gesture involving interaction with the notification.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Gesture detection techniques involving three dimensions are described that may be utilized in a variety of ways to provide inputs to a computing device. A computing device, for instance, may have a display device that includes touch sensors that are configured to detect proximity of an object, e.g., a user's finger, to a surface of the display device to support touchscreen functionality. The detected proximity of the object may include contact with a surface of a display device and may also include detection of a proximity of an object that does not involve contact, such as gestures that are detectable in three dimensions “off screen” of the display device.

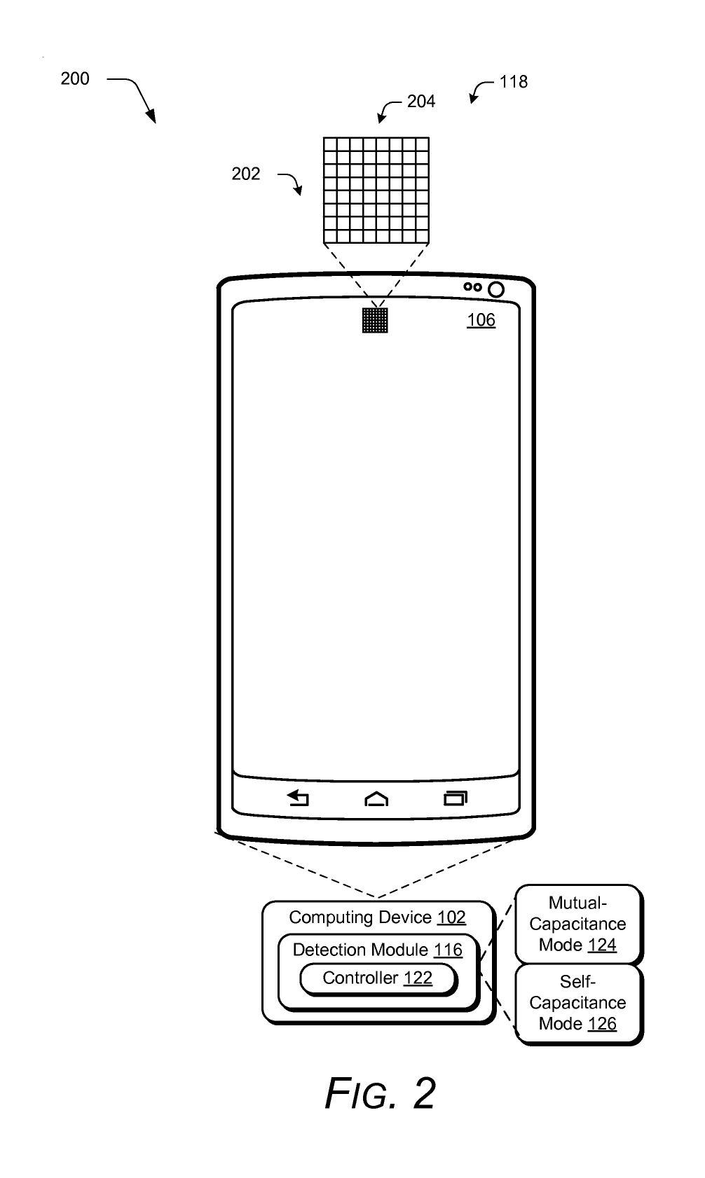

The touch sensors described herein may be configured to operate in a plurality of different modes through use of a controller to support this onscreen and off-screen detection and thus may be utilized without use of additional hardware. A first one of these modes, for example, is a mutual capacitance mode that causes the controller to configure the touch sensors to detect close proximity of an object using mutual capacitance. As further described in relation to FIG. 2, for instance, this may be performed by using driving lines and sensing lines of the touch sensors formed in an x/y grid (e.g., from lines of indium tin oxide formed over a display module) to determine x/y coordinates of a likely position of the object. This may be performed to support user interaction with a user interface displayed by the display device to determine “fine” position of a user's finger, support multi-touch gestures, and so on. Characteristics of this mode include high resolution, high speed, with relatively high power usage.

A second example of these modes is a self-capacitance mode which causes the touch sensors in this case to detect proximity of an object at a distance from a surface of the display device using self-capacitance. The self-capacitance mode, for instance, may employ a single layer of the individual touch sensors that are used in the mutual-capacitance example above as also described in greater detail in relation to FIG. 2, but in this instance are used to detect proximity of the object at a variety of distances from a surface of the display device using self-capacitance and therefore may be utilized to detect the object in three dimensions, including movement of the object. Additionally, this mode may be supported using hardware that may also be used for mutual capacitance, thereby supporting this increased sensing range without inclusion of additional components as is conventionally performed, e.g., to include IR sensors to support “off surface” detection of proximity of objects. Characteristics of this mode include low power usage, high sensitivity and long distance detection with low resolution.

A variety of different functionality may be supported through use of the self-capacitance mode. In this mode, for instance, a range of detection may be increased in comparison with mutual capacitance and thus may be utilized to recognize three dimensional gestures. Therefore, this may be used to detect a gesture involving movement in three dimensions by sensing an object as approaching the display device and thus used to wake the display device as the object nears the surface without actually touching the surface, which may be used to reduce latency in waking the display device. Similar techniques may also be employed to wake a processing system of the computing device, and therefore may be utilized to conserve power.

Additionally, the self-capacitance mode may be utilized to consume less power than the mutual-capacitance mode through use of a reduced scan rate such that a scanning frequency is less than in the mutual capacitance mode. Therefore, once proximity of an object is detected using the self-capacitance mode, the controller may switch to a mutual-capacitance mode to increase resolution of the scanning. A variety of other examples are also contemplated, such as to support gesture detection in the self-capacitance mode by scanning different collections of the sensors, which may be used to support interaction with a notification of a user interface, such as to ignore a communication using a horizontal swipe gesture, and so forth. Further discussion of these and other techniques may be found in relation to the following sections.

In the following discussion, an example environment is described that may employ the touch sensor mode techniques described herein. Example procedures are also described which may be performed in the example environment as well as other environments. Consequently, performance of the example procedures is not limited to the example environment and the example environment is not limited to performance of the example procedures.

Example Environment

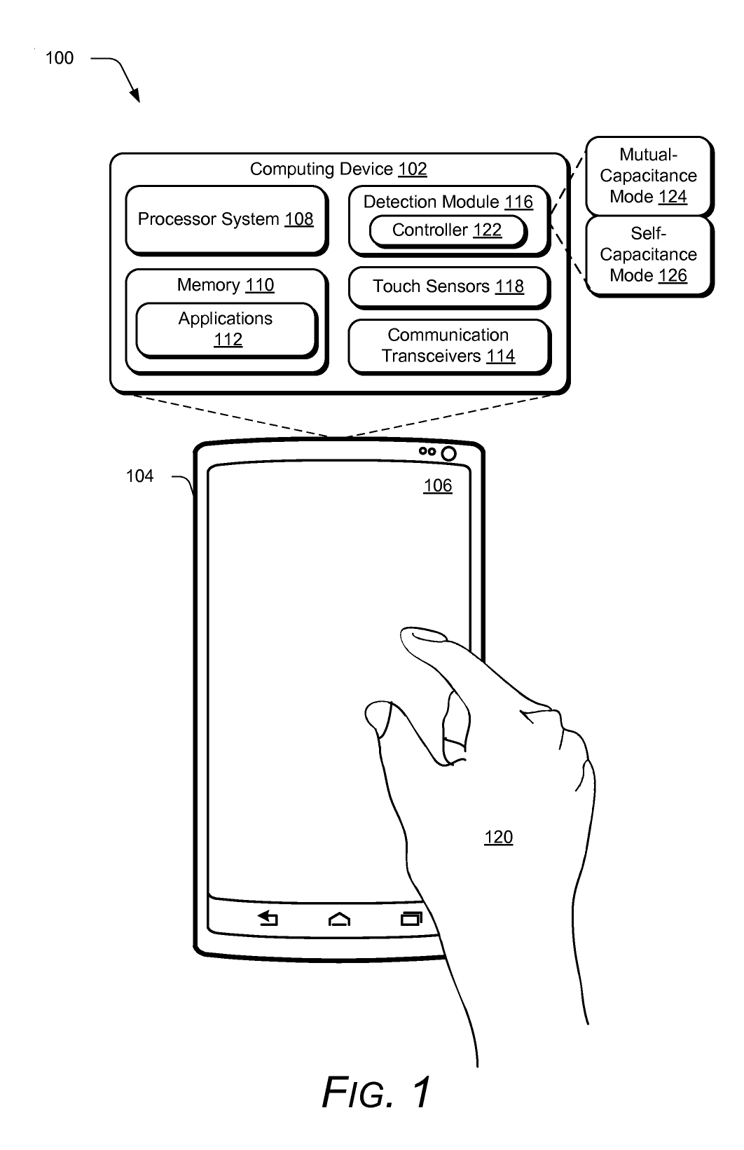

FIG. 1 is an illustration of an environment 100 in an example implementation that is operable to employ the touch sensor mode techniques described herein. The environment 100 includes a computing device 102, which may be configured in a variety of ways. For example, a computing device 102 may be configured as a mobile computing device which may include any type of wired or wireless electronic and/or computing device configured for mobile use, such as a wireless phone, tablet computer, handheld navigation device, portable gaming device, media playback device, or any other type of electronic and/or computing device. Other non-mobile examples are also contemplated, such as a traditional desktop PC.

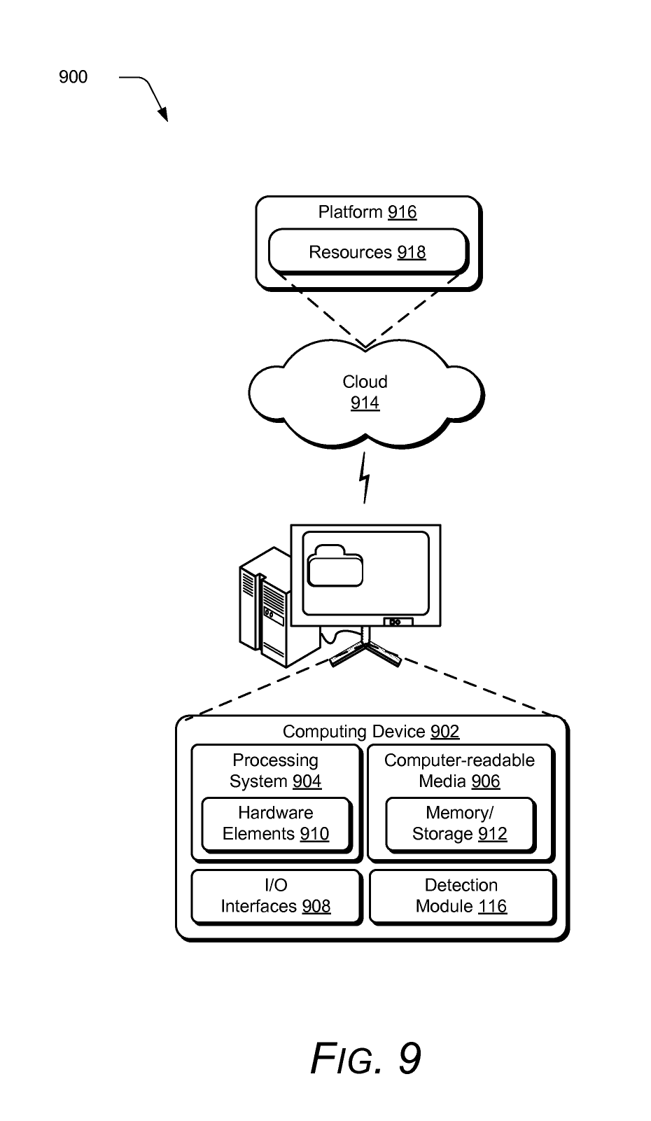

Generally, any of the devices described herein can be implemented with various components, such as a housing 104 having secured thereto a display device 106. The housing 104 may also include disposed therein a processor system 108 (e.g., a CPU), an example of a computer-readable storage medium illustrated as memory 110 configured to maintain one or more applications 112 that are executable on the processor system 108, and one or more communication transceivers 114 configured to support wired and/or wireless communication. It should be readily apparent that these are just examples and as such other numbers and combination of differing components are also contemplated as further described with reference to the example device shown in FIG. 9.

The computing device 102 is also illustrated as including a detection module 116 that is representative of functionality to detect proximity of objects using one or more touch sensors 118. The touch sensors 118, for instance, may be included as a layer over a display module of the display device 106 to support touchscreen functionality, such as to detect proximity of a finger of a user's hand 120. The detection module 116 in this instance includes a controller 122 that is separate from the processing system 108 and usable to detect this proximity while the processor system 108 and even the display device 106 are in a sleep state to consume less power.

A variety of different gestures may be detected by the detection module 116 through use of the controller 122 to implement a plurality of touch sensors modes, examples of which are illustrated as a mutual-capacitance mode 124 and a self-capacitance mode 126. The mutual-capacitance mode 124 is configured to use the touch sensors 118 to detect proximity of an object, such as the finger of the user's hand 120, using mutual capacitance which may be utilized to perform high resolution detection at or near a surface of the display device 106. The self-capacitance mode 126 is configured to use the same touch sensors 118 used in the mutual-capacitance mode 124 to detect proximity of an object using self-capacitance, but may do so at an increased range in comparison with the mutual-capacitance mode that may support three dimension gesture detection. In this way, different modes and corresponding functionality may be supported without adding additional hardware to the computing device 102. Further discussion of the mutual-capacitance mode 124 and the self-capacitance mode 126 may be found in the following and shown in a corresponding figure.

FIG. 2 depicts an example implementation 200 showing an example of the touch sensors 118 of FIG. 1 in greater detail. The touch sensors 118 in this example are configured as a grid having rows 202 and columns 204 of conductors that are disposed in separate layers. In a mutual-capacitance mode 124, either of the rows 202 or columns 204 is configured as a driving line, which carries current, and the other is used as sensing lines, which detect capacitance at nodes formed in the grid that is inherently formed at each intersection.

For example, proximity of an object close to a surface of the display device 106 that includes the sensors 118 may cause a change in a local electrostatic field, which reduces the mutual capacitance at that location. The capacitance change at every individual node on the grid may thus be measured to determine “where” the object is located by measuring the voltage in the other axis.

In this way, a scanning rate may be utilized to scan individual nodes to detect capacitance at each node and thus whether an object is proximal to those nodes, which provides sufficient resolution to interact with a user interface output by the display device 106 to support fine finger position, multi-touch operation, track a stylus, and so forth.

In the self-capacitance mode 126, the rows 202 and/or columns 204 of the conductors of the touch sensors 118 may be used. For example, either layer of conductors of the rows 202 or columns 204 may be operated independently. In self-capacitance the capacitive load of a nearby conductive object is measured on each column or row electrode by the detection module 116. This technique can be more sensitive than mutual capacitance and thus may be utilized to support off-screen detection that may be leveraged to recognize gestures involving three dimensions. Self-capacitance, for instance, typically has an increased sensing range than mutual capacitance (e.g., several inches versus a few millimeters) and thus may be utilized to support a variety of functionality, an example of which is described as follows and shown in a corresponding figure.

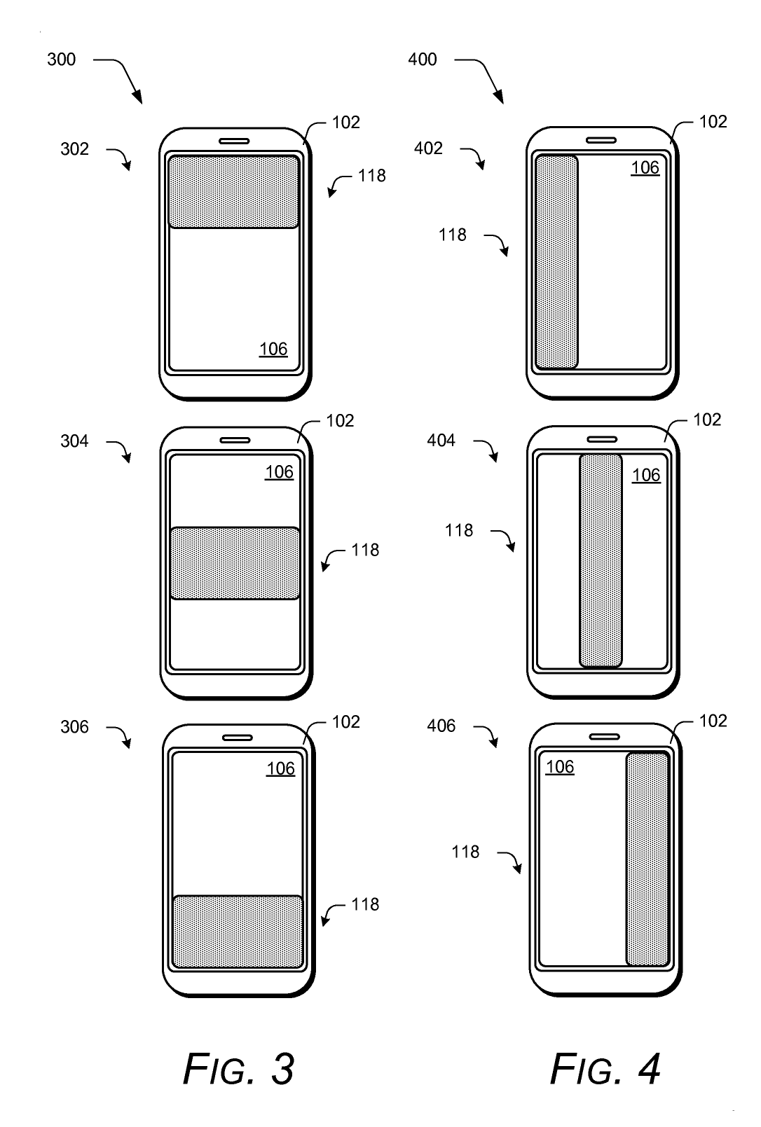

FIGS. 3 and 4 depict examples 300, 400 of scanning in a self-capacitance mode 126 using touch sensors 118 of a computing device 102 of FIG. 2. In this example, the controller 122 of the detection module 116 performs a scan in the self-capacitance mode 126 involving separate collections of the touch sensors, which may be utilized to detect movement of an object that is proximal to the sensors 118 in three dimensions by leveraging increased sensitivity of the sensors 118 than when in a mutual-capacitance mode 124.

Additionally, with fewer individually scanned channels and reduced resolution and speed requirements this scan may be performed at a slower rate than the mutual capacitance scan and thus conserve power of the computing device 102. For example, this scan in the self-capacitance mode may be performed while the display device 106 and/or processing system 108 of the computing device 102 is in a sleep state and thus may be used to wake these devices if an object is detected as proximal to the touch sensors 118. It may also be used to switch to the mutual capacitance mode 124, and so on as further described below.

As shown in FIG. 3, for instance, first, second, and third stages 302, 304, 306 of a vertical scan are shown that use different collections of the touch sensors 118 to detect proximity of the object at corresponding locations. The collections of the touch sensors 118 that are performing the scanning and corresponding locations on the display device 106 are shown in gray in FIG. 3.

At the first stage 302, touch sensors 118 located at a top portion of the display device 106 are scanned using self-capacitance to detect proximity of an object. At the second stage 304, touch sensors 118 located at a middle portion of the display device 106 are scanned using self-capacitance and at the third stage 306, touch sensors 118 located at a bottom portion of the display device 106 are scanned using self-capacitance. Depending on hardware configuration, sensing of these regions can also be done simultaneously rather than sequentially.

In this way, proximity of an object to these corresponding locations may be detected, which may also be used to detect vertical movement of the object through comparison of data obtained from a sequence of the scans, or multiple channels if scanned simultaneously. It should be readily apparent that the order in which the illustrated scans at the first, second, and third stages 302, 304, 306 may be changed and also that a larger or lesser number of collections are also contemplated.

Likewise, scans may also be performed in a vertical direction as shown in FIG. 4. At the first stage 402, touch sensors 118 located at a left portion of the display device 106 are scanned using self-capacitance to detect proximity of an object. At the second stage 404, touch sensors 118 located at a center portion of the display device 106 are scanned using self-capacitance and at the third stage 306, touch sensors 118 located at a right portion of the display device 106 are scanned using self-capacitance. Depending on hardware configuration, sensing of these regions can also be done simultaneously rather than sequentially.

In this way, proximity of an object to these corresponding locations may be detected, which may also be used to detect horizontal movement of the object through comparison of data obtained from a sequence of scans, or multiple channels if scanned simultaneously. Detection of proximity of an object using self-capacitance and even movement of the object may be utilized to support a variety of functionality such as three-dimension gesture detection, examples of which are described in the following and shown in corresponding figures.

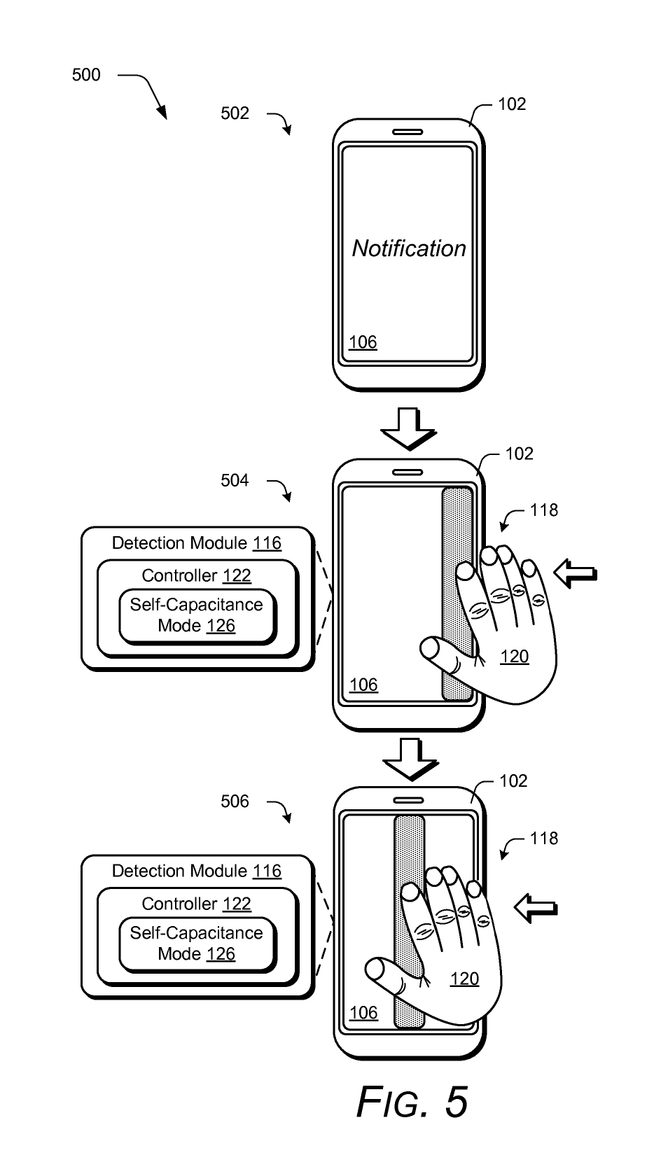

FIG. 5 depicts an example implementation 500 in which detection of a gesture in the self-capacitance mode 126 is utilized to interact with a notification output by a display device 106 of the computing device 102. This example implementation 500 is illustrated using first, second, and third stages 502, 504, 506. At the first stage 502, a notification is output by a display device 106 of the computing device 102. The notification may take a variety of forms, such as to indicate that a communication has been received (e.g., an incoming phone call, a text message, email, etc.), an application status notification, a power level indication, an alarm clock, and so on that may be output as part of a lock screen of the computing device 102, on a home screen, a pop-up menu, and so forth. Other notifications are also contemplated, such as an audio notification (e.g., a phone ringing), a “chirp” upon receipt of a text message, and even lack of a notification whatsoever.

At the second and third stages 504, 506, right and center portions of the display device 106 are scanned using corresponding touch sensors 118 in a self-capacitance mode 126. At each of these scans, proximity of an object (e.g., a user's hand 120) is detected and identified as horizontal motion of the object. This motion may be recognized as a swipe gesture, which may be utilized to initiate functionality of the computing device 102 to interact with the notification, such as to answer or ignore a communication such as a phone call or message, and so on.

Thus, in this example the gesture may be performed by a user by waving a hand 120 over the display device 106, without contacting a surface of the display device 106, to interact with the computing device 102. In this way, “off screen” 3D gestures may be supported by the computing device without inclusion of additional hardware (e.g., IR sensors) through support of the touch sensor modes. A variety of other gestures may also be recognized in the self-capacitance mode 126, which may be supported through use of horizontal and vertical scanning to detect horizontal and vertical movement as previously shown and described in relation to FIGS. 3 and 4.

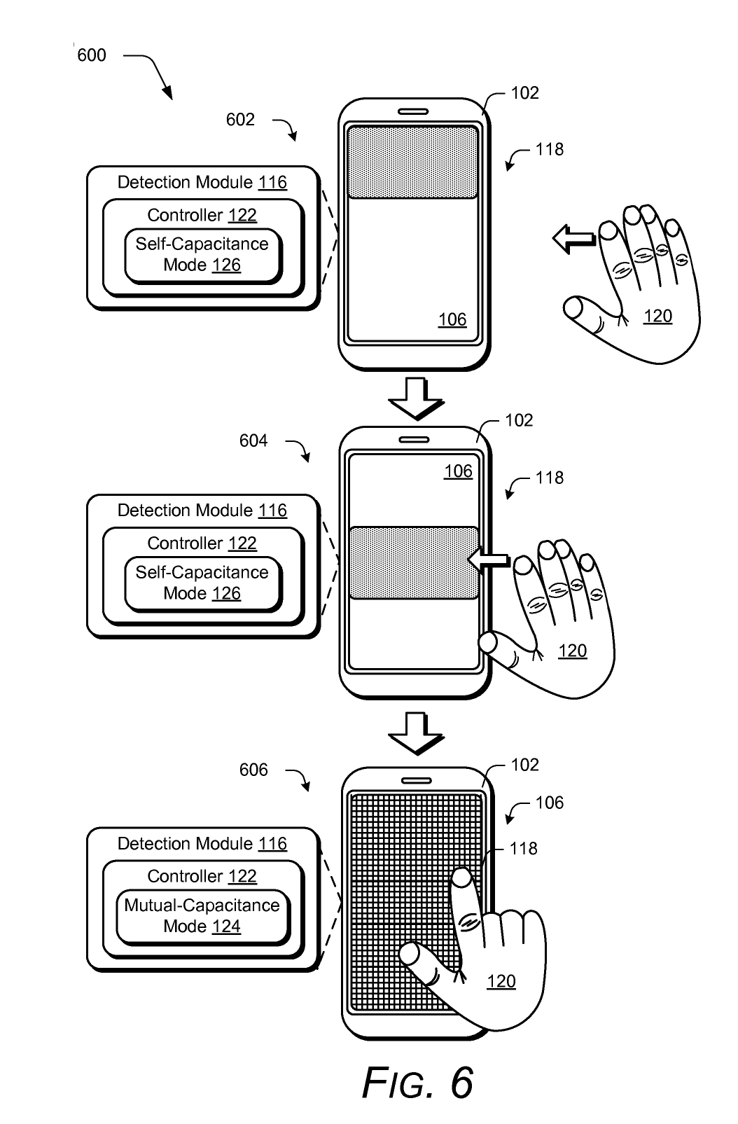

FIG. 6 depicts an example implementation 600 in which detection of an object in a self-capacitance mode 126 is used to switch to the mutual-capacitance mode 124. This example implementation 600 is illustrated using first, second, and third stages 602, 604, 606. At the first stage 602, a controller 122 of the detection module 116 causes the touch sensors 118 to operate in a self-capacitance mode 126 to scan a top portion of the display device 106. At this stage, a user's hand 120 is moving towards touch sensors 118 but is not yet sensed using self-capacitance.

At the second stage 604, the controller 122 of the detection module 116 causes the touch sensors 118 to operate in the self-capacitance mode 126 to scan a middle portion of the display device 106. Proximity of the object, e.g., the user's hand 120, is detected by the detection module 116, which causes the controller 122 to operate the touch sensors in a mutual-capacitance mode 124 as shown at the third stage 606.

Thus, in this example components of the computing device 102 such as the processing system 108, display device 106, and so on may be in a sleep state at the first and second stages 602, 604. Detection of the proximity of the object may then cause the switch to the mutual-capacitance mode 124 to support increased location resolution of objects, multi-touch gestures, as well as wake the display device 106, processing system 108, and so on to put the computing device 102 in a normal operational state.

In this way, resources (e.g., power) of the computing device 102 may be conserved, latency in “waking up” the components in the sleep state may be lessened due to the increased sensing range of the self-capacitance mode 126, and so on. Other examples are also contemplated, such as to recognize gestures in the self-capacitance mode 126, an example of which is described as follows and shown in a corresponding figure.

Example Procedures

The following discussion describes display device touch sensor mode techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

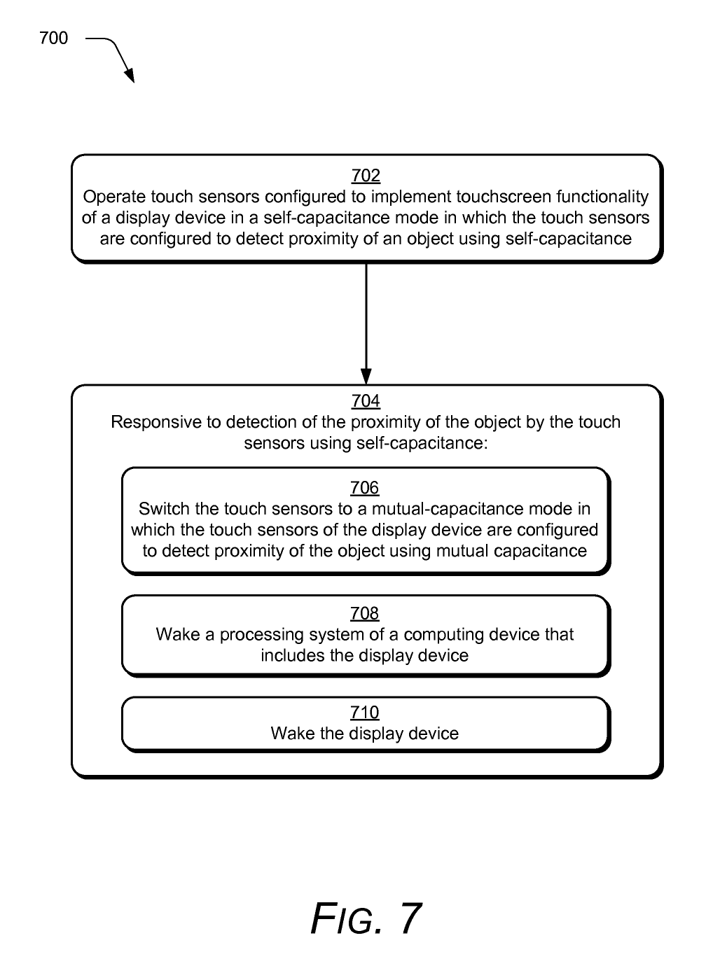

FIG. 7 depicts a procedure 700 in an example implementation in which a plurality of touch sensors modes are employed to configure touch sensors to detect proximity of an object. Touch sensors configured to implement touchscreen functionality of a display device are operated in a self-capacitance mode in which the touch sensors are configured to detect proximity of an object using self-capacitance (block 702). As shown in FIGS. 3-6, for instance, the touch sensors 118 may operate in the self-capacitance mode 126 such that conductors of the touch sensors 118 are utilized individually along with capacitance-sensing circuitry of the detection module 116 to detect capacitance.

Detection of proximity of the object by the touch sensors using self-capacitance (block 704) may be utilized to support a variety of functionality. For example, responsive to detection of the proximity of the object by the touch sensors using self-capacitance, the touch sensors may be switched to a mutual-capacitance mode in which the touch sensors of the display device are configured to detect proximity of the object using mutual capacitance (block 706), such as to detect capacitance at nodes of the grid as shown and described in relation to FIG. 2.

In another example, three dimensional gestures may be detected and corresponding operations initiated in response to this detection. For example, responsive to the detection of the proximity of the object by the touch sensors using self-capacitance, a processing system is wakened of a computing device that includes the display device (block 708). In a further example, responsive to the detection of the proximity of the object by the touch sensors using self-capacitance, the display device is wakened of a computing device (block 710).

In these ways, power consumption of the computing device 102 may be reduced by operating the touch sensors 118 as well as the display device 106 and processor system 108 in a reduced-power state (e.g., sleep state) until an object is detected. This may also be performed to reduce latency in waking the computing device 102, and components thereof, by leveraging an increased sensing range of self-capacitance for object detection as opposed to mutual capacitance, e.g., several inches compared to a few millimeters.

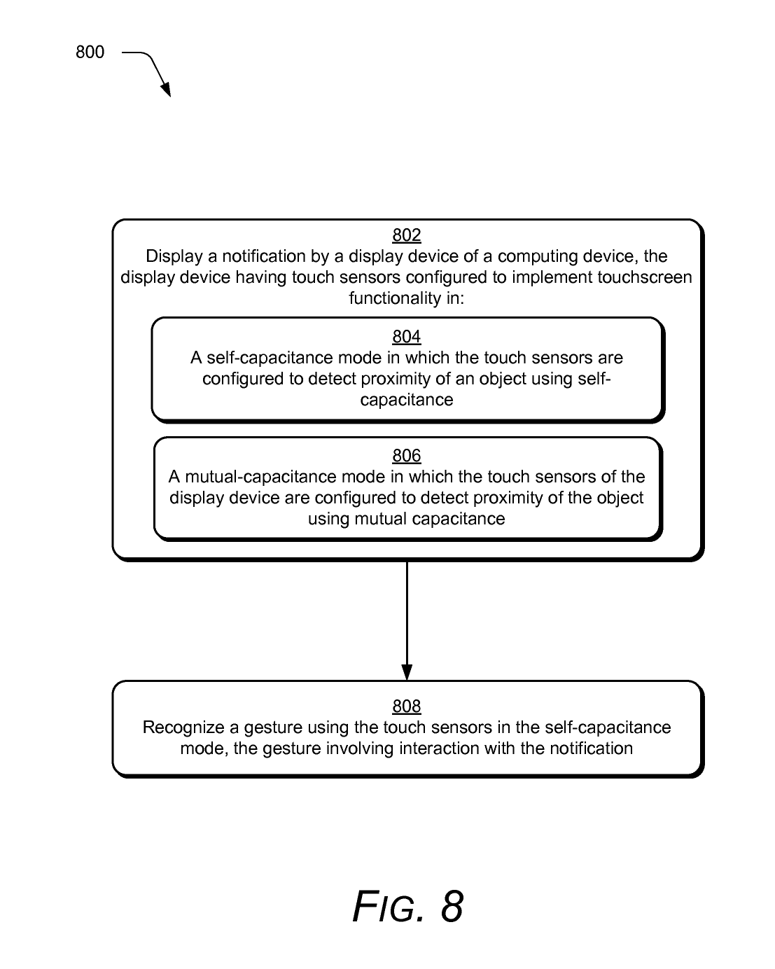

FIG. 8 depicts a procedure 800 in an example implementation in which a gesture is recognized that is detected using a self-capacitance mode of touch sensors of a display device, the gesture involving interaction with the notification. A notification is displayed by a display device of a computing device. The display device has touch sensors configured to implement touch functionality in a plurality of modes (block 802). Examples of these modes include a self-capacitance mode in which the touch sensors are configured to detect proximity of an object using self-capacitance (block 804) and a mutual-capacitance mode in which the touch sensors of the display device are configured to detect proximity of the object using mutual capacitance (block 806).

As described in relation to FIG. 2, for instance, a grid having two layers of conductors arranged in generally horizontal and vertical directions may be used to detect proximity of an object at intersections in the grid using mutual capacitance. One or both of these layers of conductors may also be configured by the controller 118 to detect proximity of an object using self-capacitance.

A gesture is recognized using the touch sensors in the self-capacitance mode, the gesture involving interaction with the notification (block 808). Successive scanning of touch sensors 118 at different locations of the display device 106, for instance, may be used to detect movement such as a “swipe” to ignore a communication, answer a phone, and so on as previously described. A variety of other gestures and notification configurations are also contemplated without departing from the spirit and scope thereof.

Example System and Device

FIG. 9 illustrates an example system generally at 900 that includes an example computing device 902 that is representative of one or more computing systems and/or devices that may implement the various techniques described herein. This is illustrated through inclusion of the detection module 116. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying a notification by a display device of a computing device, the display device having touch sensors configured to implement touchscreen functionality in:
a self-capacitance mode in which the touch sensors are configured to detect proximity of an object at a distance using self-capacitance; and
a mutual-capacitance mode in which the touch sensors of the display device are configured to detect proximity of the object using mutual capacitance; and
recognizing a gesture using the touch sensors in the self-capacitance mode, the gesture involving interaction with the notification.

2. A method as described in claim 1, wherein the operating of the touch sensors in the self-capacitance mode includes using different collections of the touch sensors to detect proximity of the object at a distance at corresponding locations.

3. A method as described in claim 2, wherein the using of the different collections is operable to recognize a gesture involving motion of the object at a distance in relation to the different collections of the touch sensors.

4. A method as described in claim 3, wherein the using of the different collections is performable to identify the gesture involving vertical motion or horizontal motion in relation to the display device.

5. A method as described in claim 1, wherein the self-capacitance mode is configured to detect the proximity of the object at a distance that does not involve contact with the display device.

6. A method as described in claim 1, wherein the self-capacitance mode has a lower scanning rate, an increased sensing distance, and consumes less power using the touch sensors than the mutual-capacitance mode.

7. A method as described in claim 1, wherein the notification involves an alarm that is set to expire at a particular time or indicates receipt of a communication by the computing device.

8. A method as described in claim 7, wherein the gesture is configured to ignore the communication configured as an email, text message, or telephone call.

9. A computing device comprising:
a housing configured to be grasped one or more hands of a user;
a display device secured to the housing; and
a plurality of touch sensors and controller configured to implement touchscreen functionality of the display device using:
a self-capacitance mode in which the touch sensors are configured to detect proximity of an object at a distance using self-capacitance; and
a mutual-capacitance mode in which the touch sensors of the display device are configured to detect proximity of the object using mutual capacitance.

10. A computing device as described in claim 9, wherein the controller is configured to wake a processing system of the computing device upon detection of the proximity of the object in the self-capacitance mode.

11. A computing device as described in claim 9, wherein the controller is configured to switch the plurality of touch sensors to the mutual-capacitance mode upon detection of the proximity of the object at a distance in the self-capacitance mode.

12. A computing device as described in claim 9, wherein the controller is configured to wake the display device upon detection of the proximity of the object at a distance in the self-capacitance mode.

13. A computing device as described in claim 9, wherein the controller is configured to recognize a gesture using the plurality of touch sensors in the self-capacitance mode.

14. A computing device as described in claim 13, wherein the gesture involves interaction with a notification output by the computing device.

15. A method comprising:
operating touch sensors, configured to implement touchscreen functionality of a display device, in a self-capacitance mode in which the touch sensors are configured to detect proximity of an object at a distance using self-capacitance; and
responsive to detection of the proximity of the object at a distance by the touch sensors using self-capacitance, switching the touch sensors to a mutual-capacitance mode in which the touch sensors of the display device are configured to detect proximity of the object using mutual capacitance.

16. A method as described in claim 1, wherein the operating of the touch sensors in the self-capacitance mode includes using different collections of the touch sensors to detect proximity of the object at a distance at corresponding locations.

17. A method as described in claim 16, wherein the using of the different collections is operable to recognize a three dimensional gesture involving motion of the object at a distance in relation to the different collections of the touch sensors.

18. A method as described in claim 17, wherein the using of the different collections is performable to identify the gesture involving vertical motion or horizontal motion in relation to the display device.

19. A method as described in claim 15, wherein the self-capacitance mode has a lower scanning rate, an increased sensing distance, and consumes less power using the touch sensors than the mutual-capacitance mode.

20. A method as described in claim 15, further comprising responsive to the detection of the proximity of the object at a distance by the touch sensors using self-capacitance, waking a processing system or the display device of a computing device that includes the display device.
